(19) United States
(12) Patent Application Publication
(10) Pub. No.: US 2011/0173535 A1
(43) Pub. Date: Jul. 14, 2011

(54) MECHANISM FOR A VENDING MACHINE GRAPHICAL USER INTERFACE UTILIZING XML FOR ON-THE-FLY LANGUAGE SELECTION BY AN END USER

(75) Inventors: William C. Royal, JR., Oak Ridge, NC (US); Viktor Partyshev, Kiev (UA); James M. Canter, Austin, TX (US); Iaroslav Voitovych, Irpin (UA)

(73) Assignee: CRANE MERCHANDISING SYSTEMS, INC., Bridgeton, MO (US)

(21) Appl. No.: 13/005,430

(22) Filed: Jan. 12, 2011

Related U.S. Application Data
(60) Provisional application No. 61/335,890, filed on Jan. 12, 2010.
(60) Provisional application No. 61/335,891, filed on Jan. 12, 2010.

(51) Int. Cl. G06F 3/01

(52) U.S. Cl. 715/703

(57) ABSTRACT

Text for a vending machine customer interface is supplied from one of a plurality of markup language descriptions of the customer interface text contained within storage media in the vending machine. Each markup language description is configured to cause the customer interface text to be displayed in a different human language. In response to initiation of a vend transaction, the vending machine may prompt the customer to select a preferred human language in which to transact the vend and, based on the customer selection, load customer interface text from a corresponding markup language description into the customer interface display.

### CROSS-REFERENCE TO RELATED APPLICATIONS

This application claims priority to U.S. Provisional Patent Application Ser. No. 61/335,890 entitled MECHANISM FOR A VENDING MACHINE GRAPHICAL USER INTERFACE UTILIZING XML FOR ON-THE-FLY LANGUAGE SELECTION BY AN END USER and filed on Jan. 12, 2010 and to U.S. Provisional Patent Application Ser. No. 61/335,891 entitled MECHANISM FOR A VENDING MACHINE GRAPHICAL USER INTERFACE UTILIZING XML FOR A VERSATILE CUSTOMER EXPERIENCE and filed on Jan. 12, 2010. This application is related to the subject matter of U.S. patent application Ser. No. ______ (Attorney Docket CRAN01-00325) entitled MECHANISM FOR A VENDING MACHINE GRAPHICAL USER INTERFACE UTILIZING XML FOR A VERSATILE CUSTOMER EXPERIENCE and filed on Jan. 12, 2011. The content of the above-identified patent documents is hereby incorporated by reference.

### TECHNICAL FIELD

The present application relates generally to vending machines and, more specifically, to dynamic language selection within the customer interface to a vending machine.

### BACKGROUND

Vending machines are often manufactured for distribution to diverse geographic markets, and must therefore be designed to operate with different currencies and/or present a customer interface in different languages. Modular currency acceptors or handlers and modular or programmable user interface components for the user interface may reduce overall manufacturing costs for a design shipped to geographically diverse regions for use, but still require customization and set-up during ordering and/or installation, and may not sufficiently allow customers to interact in a preferred language.

In addition, vending machines are frequently placed in airports, train stations, or other public place where the general consumer population do not all speak/read/write the same language, or even come from the same geographic region. Inability to interact with automated equipment efficiently, especially in the public locations where vending machines are typically located, is often cited as a reason why individuals choose not to make a purchase. If a vending machine consumer is not able to readily determine how to operate the machine, or if they feel that they will not understand payment amount or terms associated with the purchase, they may simply choose not to make a vend purchase at all.

Some vending machines alleviate some language-based impediments to vend sales by presenting the actual products to be vended to the customer through a transparent front, as in the case of snack machines or packaged beverage machines. However not all language-specific portions of a vend purchase can be eliminated by such product display, since text-based instructions regarding payment or product selection may still be required. Moreover some vend products can be readily displayed, as in the case of coffee or other hot, brewed beverages. Machines for vending coffee (American or European style), espresso, and other hot brewed beverages necessitate at least some text-based (rather than purely graphical) customer interaction to make selections, especially if different brews or flavors are offered.

There is, therefore, a need in the art for a vending machine enabling dynamic customization of language for the customer interface.

### SUMMARY

Text for a vending machine customer interface is supplied from one of a plurality of markup language descriptions of the customer interface text contained within storage media in the vending machine. Each markup language description is configured to cause the customer interface text to be displayed in a different human language. In response to initiation of a vend transaction, the vending machine may prompt the customer to select a preferred human language in which to transact the vend and, based on the customer selection, load customer interface text from a corresponding markup language description into the customer interface display.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a brewed beverage vending machine employing markup language descriptions for dynamic customer interface language selection for a graphical user interface according to one embodiment of the present disclosure;

FIG. 1A illustrates in greater detail the user interface portion of the brewed beverage vending machine of FIG. 1;

FIG. 1B is a block diagram of selected electrical, electronic and/or electro-mechanical subsystems within the brewed beverage vending machine of FIG. 1;

FIGS. 2A and 2B are block diagrams depicting the architecture of and data flow within the hardware and software control systems within a brewed beverage vending machine employing markup language descriptions for dynamic customer interface language selection for a graphical user interface according to one embodiment of the present disclosure;

FIG. 3 is a more detailed block diagram of a content manager within the architecture of FIGS. 2A and 2B;

FIG. 4A depicts a state diagram for a simplified implementation of the state machine in FIG. 2;

FIG. 4B depicts a state diagram for a realistic implementation of the state machine in FIG. 2; and

FIG. 5 is a high level flow diagram for a process of employing markup language descriptions for dynamic customer interface language selection for a graphical user interface within a brewed beverage vending machine according to one embodiment of the present disclosure.

### DETAILED DESCRIPTION

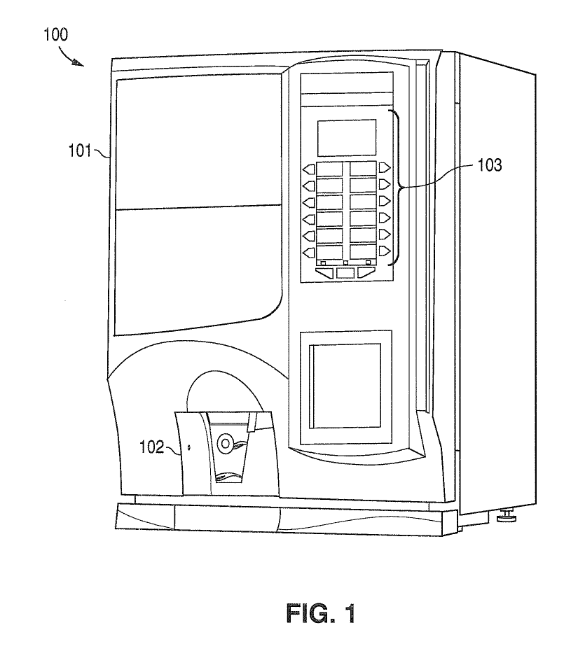

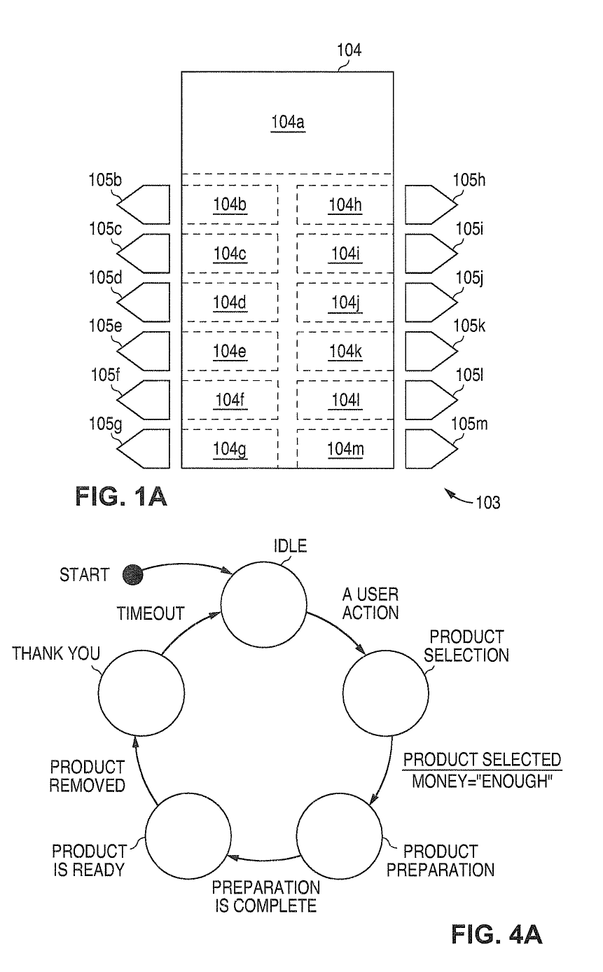

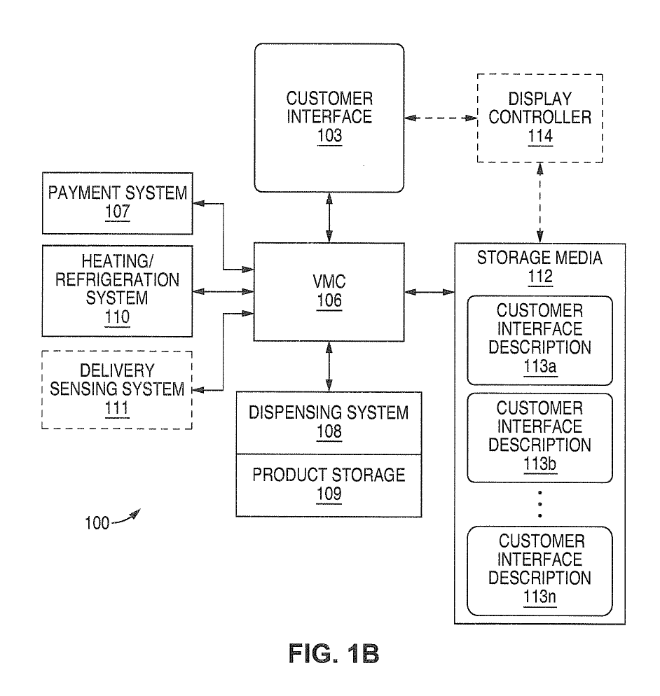

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine.

FIG. 1 illustrates a brewed beverage vending machine employing markup language descriptions for dynamic customer interface language selection for a graphical user interface according to one embodiment of the present disclosure. The system 100 includes a cabinet 101 housing the internal components of the vending machine and including a delivery station 102 at which, in the exemplary embodiment, hot or cold brewed beverages are delivered to the customer. System 100 also includes a graphical user (customer) interface providing dynamic information to the customer during a vend transaction such as the status of payment or available product selections, and enables the customer to select products, obtain refunds of currency deposited, and/or obtain additional information regarding products available or vend purchase terms. User interface 103, illustrated in greater detail in FIG. 1A, includes a graphical display 104 that, to the customer using the vending machine, appears physically divided into a main display area 104a and a plurality of label display areas 104b-104m by overlying material (e.g., plastic) illustrated in phantom in FIG. 1A. As illustrated, a plurality of user interface controls 105b-105m (e.g., press-activated switches) corresponds to the plurality of label display areas 104b-104m. In alternate embodiments, however, a direct touch-screen display may enable user selection based on the label display areas.

FIG. 1B is a block diagram of selected electrical, electronic and/or electro-mechanical subsystems within the brewed beverage vending machine of FIG. 1. The system 100 includes a central controller 106, which may be implemented as a vending machine controller (VMC) of the type known in the art, that is communicably coupled to the graphical user (customer) interface 103. VMC 106 is also communicably coupled to, and receives control signals from and may supply control signals to, a payment system 107 such as a bill acceptor/recycler, a coin mechanism, and/or a credit or debit card payment system, all of which are known in the art. VMC 106 is communicably coupled to and controls an electromechanical dispensing system 108, which is mechanically coupled to or operable with product storage 109. VMC 101 is further communicably coupled to and controls a heating and/or refrigeration heating system 110, and may be further communicably coupled to and receive control signals from an optional delivery sensing system 111.

As noted above, the exemplary embodiment is preferably a coffee vending machine for dispensing hot beverages brewed to order. As such, the product storage 109 will typically include coffee beans or grounds, or other substances from which a hot beverage may be brewed (e.g., tea leaves, cocoa powder, etc.) and cups. The dispensing system 108 will normally include a mixing chamber for mixing the substance to be brewed with hot water and a channeling system for delivering the hot brewed beverage. An example of the internal structure of such a coffee vending machine is found in U.S. patent application Ser. No. 12/958,172 entitled MODULAR COFFEE BREWER WITH CONTINUOUS FILTER BELT and filed Dec. 1, 2010, the content of which is hereby incorporated by reference.

Those skilled in the relevant art will recognize that the full construction and operation of a vending machine is not depicted in the drawings or described herein. Instead, for simplicity and clarity, only so much of a brewed beverage vending machine as is unique to the present disclosure or necessary for an understanding of the present disclosure is depicted and described. In alternative vending machine embodiments, the product storage 109 may take the form of helical coils holding snack products, with the dispensing system 108 including motors for turning the helical coils. In still other vending machine embodiments, the product storage 109 may be trays holding packaged beverages in upright position, while the dispensing system 108 includes an X-Y product retrieval mechanism. Such designs are known to those skilled in the relevant art. In addition, the techniques of the present disclosure may be implemented in other types of systems than vending machines, such as automated teller machines (ATMs), bus/train/plane ticket kiosks, fuel dispensers, and self-checkout supermarket registers.

Vending machines, as well as automated teller machines, ticket kiosks, fuel dispensers, and self-checkout supermarket registers, are all “terminal”-like devices that traditionally have had to manage multilingual interfaces for the general population, but have not always done this in a flexible manner. HyperText Markup Language (HTML) interfaces to web sites, on the other hand, are designed for a global audience, and have developed techniques and tools that provide sophisticated infrastructure for dynamic language selection, units of measure (including currency), etc. The concept is sometimes referred to as localization.

In the present disclosure, system 100 includes storage media 112 communicably coupled to VMC 106, and may optionally include a display controller 114 separate from VMC 106 coupled between customer interface 103 and storage media 112 performing or facilitating the processes described below. Storage media 112 may take the form of “flash” memory, Erasable Electrically Programmable Read Only Memory (EEPROM), or any other suitable type of data storage media, preferably non-volatile and adapted to be overwritten as well as read during the operating lifetime of the system 100.

Within storage media 112 are markup language customer interface descriptions 113a-113n. As used herein, “markup language” includes text-based definitions of user interface content (rather than purely graphical content rendered by machine-specific executable code) and includes, by way of example, HTML and in a preferred embodiment eXtensible Markup Language (XML). The exemplary embodiment of the design disclosed uses XML to define all the text associated with the system customer interface, using a flexible but predetermined grammar for describing textual elements using XML tags. The XML description defines all specific textual elements in a dictionary based on these XML tags, grouped by language. This mechanism in turn is used by a flexible language switching mechanism in the presentation layer of the customer interface. Change of language is subsequently driven by a selection event in the customer interface. The selection event could be associated with pressing a physical button (such as but not limited to a reprogrammable soft key) on the exterior of the vending machine, or pressing a “virtual” button on a touchscreen user interface.

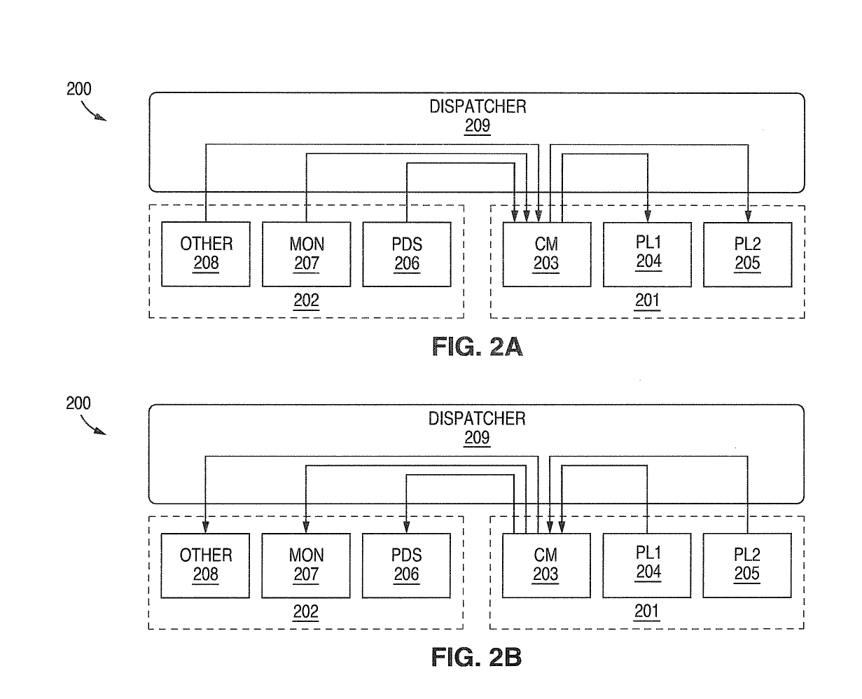

FIGS. 2A and 2B are block diagrams depicting the architecture of and date flow within the hardware and software control systems within a brewed beverage vending machine employing markup language descriptions for dynamic customer interface language selection for a graphical user interface according to one embodiment of the present disclosure. The control system architecture 200 incorporates the “separation of concerns” (SoC) architectural pattern, with components logically grouped based on whether the respective component is actively involved in a process of concern or is merely reactive to the process and/or are relatively independent of the user interface processes. In the present disclosure, the hardware for system 100 is logically divided into the user interface components 201 and the components 202 for the remainder of the system. The user interface components 201 include a content manager 203 and presentation layers PL1 204 and PL2 205. There is preferably one presentation layer for each user interaction device. Thus presentation layer PL1 204 is associated with user interface display 104 and switches 105b-105h (or the touch screen display mentioned above) in the exemplary embodiment, while presentation layer PL2 205 is associated with some other user interaction device not shown in the exemplary embodiment (e.g., a 7-segment display and/or additional buttons). In embodiments with more than two user interaction devices, additional presentation layers would be provided for each such user interaction device.

The remaining components 202 for system 100 are logically grouped by process, and may include the same hardware device in different components. These are the “rest of the system” components, or the system components other than the user interface subsystem. Thus, for example, the product delivery system (PDS) component 206 includes the VMC 106 and dispensing system 108, while the monetary (MON) component 207 also includes the VMC 106, and includes the payment system 107 as well. Another component 208 might also include the VMC 106, together with one or more other hardware devices. For instance, a “Cabinet” component might be included, encompassing the product delivery sensing system at the delivery station 102. Components in the “rest of the system” group 202 may vary, because a particular embodiment may have the components shown or quite another set of components, to fulfill the particular system's purposes.

All communication between the logically grouped components is made via a dispatcher 201, the system-wide messaging engine. If a component wants to send data and/or an event notification to one or more other component(s), the data/event notification is sent in the form of a message to the dispatcher 209, which forwards that message to all components previously subscribed to such a message.

The content manager component 203 is the root of the user interface the architecture 200 depicted, providing a data path connection between the presentation layer(s) 204 and 205 and the remainder of the system 100. The content manager 203 knows the language of system messages, interprets incoming data, and builds the content for one or more presentation layer component(s) to display according to the data received from the remainder of the system in the “forward” data path depicted in FIG. 2A (the path of event or message propagation from the remainder of the system to the display 104). Different activities in the system will result in changes to the user interface content, with an event triggering the change of the content propagating from some subsystem as a message via the dispatcher 209 to the content manager 203, and the content manager 203 determining what needs to be done with the user interface display content in a response to that event. For example, when a product is prepared and ready, the product delivery subsystem 206 (or, alternatively, the “Cabinet” component described above) sends a “Dispensed” message to the content manager 203. The content manager then determines (as described below) what media to display in order to show the user that the product is ready, prompting the user to remove the product from the delivery port 102.

When a user makes some input to a user interaction device, the content manager 203 receives and processes a message from a presentation layer component and, if needed, sends the proper message to the remainder of the system via the “backward” data path depicted in FIG. 2B (the path of data propagation from the user-input to the “rest of the system”). The customer plays an active role in the vending machine operation, such that when a customer selects an available product (by pressing a key/button, switch or a portion of a touch-screen), the presentation layer will send a “backward” message to the content manager with the information identifying the action needed in the response to the button pressed. Then the content manager will process the message received and send a message to the remainder of the system with the information about the user's selection, and/or change its internal state to reflect the user's input. The content manager serves as an effective firewall, preventing presentation layers from sending unexpected messages directly to the remainder of the system. The limited set of allowed messages and the rules of their composition are defined by the system developer and placed in the System Communicator Configuration File, a configuration file controlling the System Communicator component of the Content Manager, described in further detail below.

Each presentation layer is a media rendering engine and user input acceptor for the specific user interaction device(s). In the exemplary embodiment, the presentation layer 204 for the user interface 103 is Adobe Flash Player, which is an effective user interface engine for many devices that handles vector graphics, animation and video streams and supports scripting (ActionScript) and supports user input screen objects. Another example of a possible presentation layer for the ATLAS Architecture is a web browser (e.g. Mozilla Firefox, Microsoft Internet Explorer or Apple Safari), which provide a similar set of content rendering and user interaction functionality.

Thus, each presentation layer has two major functions: rendering content and accepting user input. Content rendering starts by receiving a “content pack” from the content manager. Acceptance of user input occurs when a user presses a key or makes some another user input device interaction, and results in a “backward” message sent back from a presentation layer to the content manager. A presentation layer is usually implemented as engine and adaptor pair, where the engine is a ready-to-use application (e.g. Flash Player), and the adaptor is a special application allowing a presentation layer engine to communicate via the Dispatcher messaging. However, presentation layer may be implemented as a single application by joining both adaptor and engine functionality within a single executable.

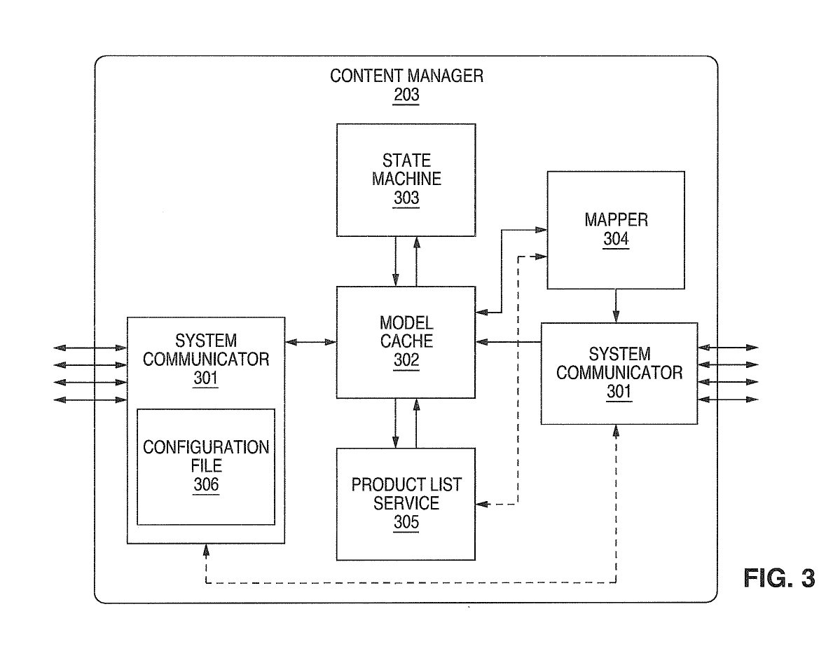

FIG. 3 is a more detailed block diagram of a content manager within the architecture of FIGS. 2A and 2B, showing the internal components, internal communication paths, and the manner in which the content manager 203 communicates to the rest of the system. When the system 100 (by some of the components) wants to change or update the content on any portion of the user interface display 104, a message is sent to the content manager 203 (on a forward data path is flowing left-to-right in FIG. 3). The content manager 203 receives incoming messages from dispatcher 209 from the remainder of the system by a configurable communication component, the system communicator 301. The system communicator 301 parses received messages and then sends data and/or event notifications to a model cache 302, the component responsible for tracking the state of the system 100 and notifying other content manager components of state changes. A state machine component 303 controls the state of the user interface (e.g. idle state, product selection, product preparation, thank-you screen, etc.). A mapper 304 performs event and data mapping from the system's state to the content displayed on the user interface display. A product list service 305, which is a vending machine-specific component of the content manager 203, maintains the product catalog, a set of products that the vending machine has available for sale, with proper text and media and arranged into selection screens for a user. System communicator 301 also provides access to the presentation layers (on a reverse data path is flowing right-to-left in FIG. 3), which render the content into display devices and receive the user's input as described above. When user input appears, the system communicator 301 receives a “backward” message from the respective presentation layer and places the received data into the model cache 302, which then notifies the rest of the content manager components of the data reception. Any affected components process that data and update the user interface display content and/or send a message to the remainder of the system 100.

Briefly stated, the model cache 302 is a mirror of the current system state, and represents the Model in the Model View Controller (MVC) standard pattern for user interface development, which constitutes all the data representing the system with which a user interacts. Since the Model is not directly available in the architecture 200, the model state is “cached.” System 100 communicates with the content manager 203 by messages, with every message carrying an event or a data update, or both. To be able to supply every needed data to fill a user interface screen, the content manager stores the last value for each information field obtained from the system, i.e., “caches” those values within the model cache. The model cache 302 is implemented as storage of named data entries (“variables”) each having a name and value, which are both text strings (preferably Unicode text strings so that the system is internationalization and localization ready). When a value of some data from the model cache is needed (such as credit value of current vend state) that value is requested by variable name (which serves as a “key”. An example of model cache content is provided in TABLE I below:

TABLE I

| Variable Name | Variable Value |
|---|---|
| state | “Idle” |
| credit | “$3.50” |
| language | “EN” |

Model cache variable values are used to store textual data and numeric data (in textual form), and may further be used to store any data format, including XML (which is used to carry complex data). Even binary data may be stored in a model cache variable (if needed) using HEX or any other binary-to-text encoding. As a general purpose variable storage, the model cache 302 is also used to store transit data inside content manager 203, such as user input messages and the state machine current data. The model cache 302 is suitable to store large amounts of data, limited only by available system memory, although non-economic use of storage space may compromise system performance.

Another significant model cache function is notification. Many content manager components want to know if the model cache data is changed. For example, user interface display content may be updated when an established credit changes. The model cache 302 thus issues notifications for all the interested components for every variable update, so that the model cache not only tracks the state of the system but also propagates events of updates, which are primary drivers of the user interface screen update. Note that update notification is issued for every update case, including update cases where the update carries the same value as already stored in the variable value such that the actual variable value will not change. This propagates clear events without any data change, and, vice versa, to not miss the event of update even if data was not changed.

A content developer use model cache variables by referencing the variables in the content manifest file 306, as data sources for user interface filling and, most importantly, as triggers of a screen redraw/update. The mechanisms of variable use in the manifest file (not shown in FIG. 3) are described below. Model cache variables are divided into several categories, by “owner”—a component of content manager 203 that sets values of these variables. Variable categories are: content manager owned variables, system variables, user variables, and internal variables. The content manager's variables are system independent and not affected by any configuration file and are listed in TABLE II below:

TABLE II

| Variable Name | Description |
|---|---|
| state | The current state of the state machine. |
| | This variable is the primary driver of the |
| | user screen content change and is in |
| | constant use by manifest rules. |
| StateMachine.action | An incoming event for the state machine. |
| | This variable is for transit data path from |
| | incoming system messages to the state |
| | machine. A content developer should not |
| | use this variable directly, because it is |
| | the mission of the state machine to handle |
| | incoming events; however such ability |
| | exists. |

System variables are variables representing the system state; their handling is the primary function of the model cache 302. Every system variable receives a particular property of the system with an incoming update-notification message from the system. Examples of system variables may be a credit value, a progress percentage of a product preparation, a temperature of a product, and so on. System variables are system-dependent, representing the data being received from the system according to a message dictionary—a system-specific set of messages. System variable names are defined by system communicator configuration file 306, a configuration file commanding the content manager 203 on how to interpret messages from the remainder of the system. Different embodiments of the architecture 200 machines may have different sets of system variables, so a content developer should ask the system developer for a list of current system variables and their meaning. System variables used in the exemplary vending machine embodiment are listed in TABLE III below:

TABLE III

| Variable Name | Description |
|---|---|
| credit | Current credit (escrow), or the amount of |
| | money entered by user into the machine. |
| DispensePercent | A percentage of product preparation |
| | progress. |
| DispenseTIme | The remaining time until product |
| | preparation is complete. |
| cost | Cost of a particular product selected. |
| | This is requested by the Product Catalog |
| | Service component from the system. |
| total | Total cost of all product(s) selected. |
| JugMode | A Boolean value of the Jug operation mode. |

For any particular application, two files defining system-to-content-manager communication may need to be analyzed to obtain names and meanings of the system variables: the message dictionary file (not shown in FIG. 3), which is the list of all the messages going through a particular system, and the system communicator configuration file 306, which defines what messages are accepted by the content manager and which fields of these accepted messages are used in what way (usually the fields are placed in model cache variables). These two files are used by the system communicator component 301 of the content manager 203 and are described in further detail below.

User variables are variables used by content developer in the manifest file. The manifest file is specified at the start of the content manager 203 by the “-m” command line argument. A content developer is free to introduce user variables within the manifest file, and to set and use their values. User variables may have any possible names that do not conflict with other model cache variable names. A typical example is the “language” variable, which stands for the currently selected user interface language and may have values of “EN” (English), “FR” (French), “RU” (Russian), etc. Since a content developer has direct write access to the model cache 302 via the manifest file, avoidance of model cache variable name collision is important. Mistakenly writing into an already used model cache variable will have unpredictable results because components of the content manager use model cache variables and assume they have correct values and correct moments of update. System files (such as the message dictionary, the system communicator configuration file 306, the state machine configuration file, etc.) may not be accessible to content developer.

The state machine 303 controls the user interface state and is, conceptually, a set of states, a current state, and a set of rules defining state-to-state transitions in a response to input signals. State machine implementation within the content manager 203 serves is asynchronous, event-driven, fully configurable via a configuration file (which defines all states and allowed—possibly conditional—transitions between states). The state machine output is its pure state, taking input from the model cache component 302 of the content manager 203 for both incoming events and data used to compute state transition conditions.

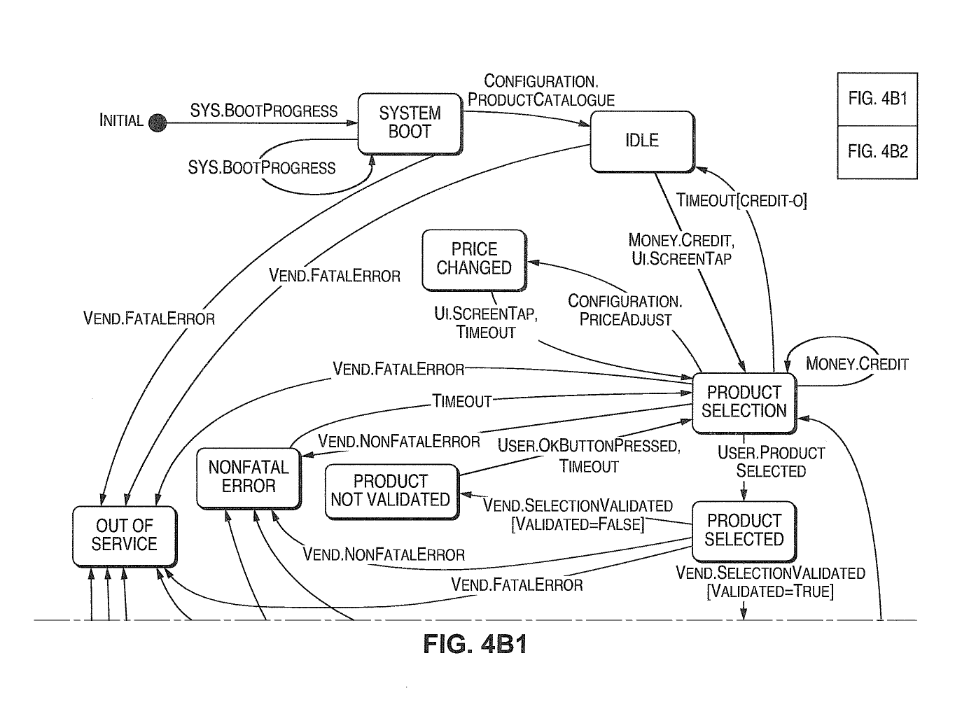

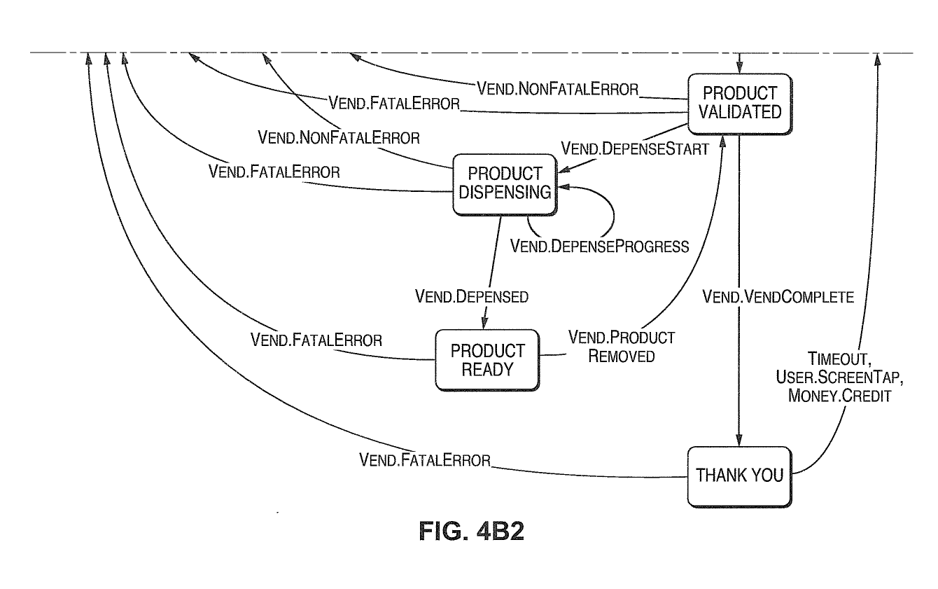

FIG. 4A depicts a state diagram for a simplified implementation of the state machine in FIG. 2. After a vending machine is started, it goes into an “Idle” state until a customer starts an interaction with the machine, at which time the machine goes into “Product Selection” state. Once the customer has selected and paid for a product, the machine transitions into a “Product Preparation” state until a “Product is Ready” state is reached, at which time the machine prompts the user to take the product. After the product is removed, the machine displays “Thank You” for a moment, and then returns into the “Idle” state. Thus, the state machine illustrated by FIG. 4A has states “Idle”, “Product Selection”, “Product Preparation”, “Product is Ready” and “Thank You”, and a set of well defined rules of state-to-state transition by certain events, provided certain conditions are met as shown on the transition's arrow.

State machine implementation within the content manager 203 works according to state machine rules represented machine-readable form and placed in an XML configuration file: the state machine configuration file (not shown in FIGS. 2 and 3). The syntax of the state machine configuration file represents the same states, transitions and rules as a state diagram, but in textual form, with every state defined as an XML element, containing nested elements for every state-to-state transition, optionally equipped with conditions required for transition to occur. Thus the content may submit an original or update state machine to a system developer in direct XML form. The XML syntax of the state machine illustrated by FIG. 4A follows:

```
<?xml version=“1.0” encoding=“utf-8”?>
<StateMachineRules initalState=“Idle”>
  <state name=“Idle”>
    <transition event=“user action” targetstate=“Product Selection”/>
  </state>
  <state name=“Product Selection”>
    <transition event=“product is selected” targetstate=“Product
Preparation”>
      <condition money=“enough”/>
    </transition>
  </state>
  <state name=“Product Preparation”>
    <transition event=“preparation complete” targetstate=“Product Is
    Ready”/>
  </state>
  <state name=“Product Is Ready”>
    <transition event=“product removed” targetstate=“Thank You”/>
  </state>
  <state name=“Thank You”>
    <transition timeout=“10” targetstate=“Idle”/>
  </state>
</StateMachineRules>
```

<?xml . . . > is a standard XML file header in 8-bit UCS Transformation Format (UTF-8) UNICODE file encoding, necessary for internationalization and localization reasons and particularly to write a text in different languages. <StateMachineRules . . . > is the root element of the state machine XML configuration file, with the “initalState” attribute of the root element sets the state machine initial state to “Idle”; the <state . . . > element defines the rules for a particular state of the state machine, a state named “Idle” in this case; child elements of the <state . . . > element define possible transitions from this state; the <transition . . . > element denotes a possible transition from the current state to a target state defined by attribute “targetstate”, where the transition takes place when an event defined by “event” attribute is occurred; the <condition . . . > element sets a condition which must be met for transition to occur, with the money=“enough” attribute means that the model variable money should have the value of “enough” for that transition to occur. Along with external incoming events, another source of the state machine transitions is timeout, generated by the state machine engine when the State Machine has been in a specified state for a specified amount of time. When the state machine persists in a state with the timeout set for the specified period of time, the timeout rule is activated and the state machine executes the transition specified by this rule (if any conditions specified for this transition are present and met).

FIG. 4B depicts a state diagram for a realistic implementation of the state machine in FIG. 2. The XML syntax of the state machine illustrated by FIG. 4B follows:

```
<?xml version=“1.0” encoding=“UTF-8”?>
<StateMachineRules initalState=“SystemBoot”>
  <state name=“SystemBoot”>
    <transition event=“SYS.BootProgress” targetstate=“SystemBoot”/>
    <transition event=“Configuration.ProductCatalogue”
targetstate=“Idle”/>
    <transition event=“Vend.FatalError” targetstate=“OutOfService”/>
  </state>
  <state name=“Idle”>
    <transition event=“Money.Credit” targetstate=“ProductSelection”>
      <condition mcname=“credit” value=“\hat{ }[1-9][0-9]*” do=“regexp”/>
    </transition>
    <transition event=“UI.ScreenTap” targetstate=“ProductSelection”/>
    <transition event=“Configuration.ProductCatalogue”
targetstate=“Idle”/>
    <transition event=“Vend.FatalError” targetstate=“OutOfService”/>
  </state>
  <state name=“ProductSelection”>
    <transition event=“Configuration.ProductCatalogue”
targetstate=“PriceChanged”/>
    <transition event=“UI.DispenseBasket” targetstate=
    “ProductDispense”>
      <condition mcname=“total” value=“\hat{ }[1-9][0-9]*” do=“regexp”/>
    </transition>
    <transition event=“Vend.Cancel” targetstate=“ThankYou”>
      <condition mcname=“credit” value=“\hat{ }[1-9][0-9]*” do=“regexp”/>
    </transition>
      <transition event=“Vend.Cancel” targetstate=“ThankYou”>
      <condition mcname=“total” value=“\hat{ }[1-9][0-9]*” do=“regexp”/>
    </transition>
    <transition event=“Vend.AddToBasketFail”
targetstate=“ProductNotValidated”/>
    <transition timeout=“120” targetstate=“Idle”>
        <condition mcname=“credit” value=“0”/>
    </transition>
    <transition event=“Vend.FatalError” targetstate=“OutOfService”/>
    <transition event=“Vend.NonFatalError” targetstate=
    “NonFatalError”/>
  </state>
  <state name=“ProductNotValidated”>
    <transition timeout=“10” targetstate=“ProductSelection”/>
  </state>
  <state name=“ProductDispense”>
    <transition event=“Vend.DispenceStart”
targetstate=“ProductDispensing”/>
    <transition event=“Vend.VendComplete” targetstate=“ThankYou”/>
    <transition event=“Vend.FatalError” targetstate=“OutOfService”/>
    <transition event=“Vend.NonFatalError” targetstate=
    “NonFatalError”/>
  </state>
  <state name=“ProductDispensing”>
    <transition event=“Vend.DispenseProgress”
targetstate=“ProductDispensing”/>
    <transition event=“Vend.Dispensed” targetstate=“ProductReady”/>
    <transition event=“Vend.FatalError” targetstate=“OutOfService”/>
    <transition event=“Vend.NonFatalError” targetstate=
    “NonFatalError”/>
  </state>
  <state name=“ProductReady”>
    <transition event=“Vend.ProductRemoved”
targetstate=“ProductDispense”/>
    <transition event=“Vend.FatalError” targetstate=“OutOfService”/>
  </state>
  <state name=“ThankYou”>
    <transition timeout=“10” targetstate=“ProductSelection”/>
    <transition event=“UI.ScreenTap” targetstate=“ProductSelection”/>
    <transition event=“Money.Credit” targetstate=“ProductSelection”>
      <condition mcname=“credit” value=“0” do=“noteq”/>
    </transition>
    <transition event=“Vend.FatalError” targetstate=“OutOfService”/>
  </state>
  <state name=“OutOfService”>
    <transition event=“SYS.BootProgress” targetstate=“SystemBoot”/>
  </state>
  <state name=“NonFatalError”>
    <transition timeout=“10” targetstate=“ProductSelection”/>
  </state>
  <state name=“PriceChanged”>
    <transition timeout=“10” targetstate=“ProductSelection”/>
    <transition event=“Money.Credit” targetstate=“ProductSelection”/>
  </state>
  <transition event=“Vend.FatalError” targetstate=“OutOfService”/>
</StateMachineRules>
```

Mapper 304 is the content manager component performing two mapping operations, event mapping and data mapping, from the system to the user, both controlled by a content developer by rules defined in the content manifest file. Mapping operations performed by mapper 304 route information from the system to the user interface display 104. “Event mapping” carries the transfer of events or of the moment of data change, and the “data mapping” performs the data transfer. In other words, the mapper 304 is the event and data flow processor controlled by manifest file.

Mapping is the process of conversion of system-driven data into a user acceptable form. The mapper 304 is responsible for “decoration” of the raw data coming from the system. The data coming from the system contains raw data fields such as a credit value, a process progress percentage, or a temperature, but the information going from the system misses user interface content data, such as images, sounds, animations, video, and localized text. The system sends events and data updates in a machine-specific form, as messages containing a name of the event, such as “VendComplete” or “DispensingStarted”, or a data update, in a form of messages, like “Temperature” with data payload of “98”, meaning that a product temperature is currently 98° C. The task of the mapper 304 is to convert these data into a form of presentation layer directives, which allow a presentation layer to display the data in the user-readable, properly visualised, internationalized and localized format, and conforming to the user interface artistic design concept. The task of the user Interface subsystem 201 of the architecture 200 is to convert raw data from the system into user-acceptable and user-convenient (user-entertaining) form. Such “decoration” is done mostly by mapper component 304, directed by the manifest file provided by a content creator.

There are three types of manifest directives: content manager directives (CM directives), data mapping directives, and presentation layer directives (PL directives). Content manager directives are executed solely by the content manager. Data mapping directives are pre-processed by the content manager 203 and then are executed by presentation layer. Presentation layer directives are transferred to the presentation layer unchanged, and are executed by presentation layer(s).

When the state of the system 100 changes, the system notifies the content manager 203 that an event occurred or of its state data change by a message sent via the dispatcher 209. By reception of such an update, the received event and/or updated data is reflected in the model cache 302, and the model cache 302 in turn notifies the mapper 304 of the system's state change (update). Mapper 304 starts its event mapping operations in the response to the signal received from the model cache 302.

The result of the mapping process is the user interface display content being sent to a presentation layer's root module in a form acceptable by the presentation layer. Thus the result of the mapping process, and the output of the mapper 304, is a presentation layer transaction, which is XML data containing the exact directives for the presentation layer of what media/application to load/unload at which target/layer and what data to send to each media/application on its target path. A presentation layer transaction is generated by mapper 304 for every individual event mapping operation, and contains the same content as a rule action but with data mapping directives substituted by the actual data.

Content developers control the mapper 304 operation by means of the manifest file, by defining event mapping rules and data mapping directives therein. The content developer also specifies presentation layer directives inside rule actions, but these directives command presentation layer(s) 204, 205, not the content manager 203.

The manifest file is an XML file that defines user interface operations in the response to system events and data updates. The manifest file defines event mapping rules and data mapping directives processed by the content manager itself, and presentation layer directives executed by the presentation layer's root module. The syntax of the manifest file is divided by two parts: a content manager driven syntax of rules and data mapping directives, and a presentation layer driven syntax of presentation layer directives dependent on the particular presentation layer implementation. The manifest file serves as a root of a content package, a package of files forming the custom user interface design for a system according to the present disclosure.

Every manifest rule has an associated condition that, when met, results in the rule becoming “active” and vice versa, (i.e., if, after some data update, a rule condition becomes false, the rule goes into an “inactive” state). When a rule becomes active, the mapper 304 executes the entry action for the rule, and when the rule becomes inactive, the mapper 304 executes the exit action for the rule.

After receiving an update notification, the mapper 304 immediately searches the manifest for the rules matching the received update. If matching rules are found, the mapper 304 takes actions defined by these rules, composing a presentation layer transaction including a set of data for one or more presentation layer(s) to display on the user screen. The event mapping mechanism is the primary driver of the user interface display content filling, change and refresh. Every update to the user interface display is a result of the event mapping process, and the user interface display is updated when and only when the manifest specifies a rule for such an event. Conversely, when the fact of a data change must be displayed on the user interface display, a rule for this event must be introduced into the manifest that defines the content to place on the display in order to reflect the update.

Data mapping takes place when an entry or exit action of a manifest rule is executed. When a particular system data update changes a particular manifest rule's activity state, the mapper 304 executes the entry or exit action defined by this rule. A rule action contains a set of presentation layer directives mixed with “data mapping” directives which command the mapper 304 to insert the current system data from the model cache 302 into the content being composed.

The product catalog is the set of data related to the current load of products within a vending machine and their place in the user interface. The product catalog is separate from the manifest file to allow a vending machine operator to alter the machine load while keeping the user interface design stable and unchanged, to exclude cost and challenges related to user interface design customization per every machine set of products change. The product catalog contains data for each product, representing a product identification, a product name (for each language in which the user interface operates), product descriptive text (for each language), product images, the product price and product options, with their identifiers, images, text and pricing. In addition, the product catalog specifies the place of each of the products in the catalog (page and position on page) as part of the catalog organization and pagination. The product catalog contains an entry for each product being loaded into the vending machine, which includes the product name and descriptive/promotional text (in all supported languages), product images per each display mode (active/inactive, small/medium/large, static/animated), and also implementation-specific fields. The product catalog also contains the product arrangement per selection page, and associates an option selection screen for each of products where option selection is required.

The product list service 305 is a functional block of the content manager 203 processing the product catalog by composing required content to display product selection screens, allowing a customer to navigate the catalog to select products and choose individual product options, and so on. The product list service 305 is vending machine specific functionality within the content manager. Applications other than a vending machine may not use the product list service component 305 at all, or may employ the product catalog and product list service for other purposes such as maintaining a list of user selectable items organized into a multi-page catalog. The state of the product catalog changes during a machine operation under the control of the product delivery service (PDS) component 206 of the architecture 200. The PDS 206 controls product availability and pricing and other aspects of the product catalog, while the content manager's duty is product catalog “decoration”—that is, association of media and localized text to each individual product/option, association of a product page to the page templates and so on.

The current product catalog data is sent by the PDS component 206 to the content manager 203 in a short form, missing user-interface context such as media files, internationalized text fields and the like. The product list service performs the task of “decoration” of the product catalog by associating the product data with the media to display on the user screen. Another function of the product list service is maintaining a “pagination” of the product catalogue, the partitioning of the entire catalog into individual pages and maintenance of user navigation through the sequence of pages. Decoration of the product catalog starts with every product catalog update received from the PDS component 206. In this process, the product list service builds a dynamic part of the manifest file and submits that data to the mapper component 304 to process. The dynamic part of the manifest file is responsible for product catalog operation and is built by the product list Service component using “templates” declared in the product list service configuration file.

The system communicator 301 is the content manager component that facilitates all the communication with the rest of the system. The system communicator 301 knows the format of the system messages flowing through the dispatcher 209, interprets and processes those messages by using a system message definition file (Message Dictionary XML file) and its own configuration file (system communicator configuration file 306). The system communicator 301 is controlled by the system communicator configuration file 306, which is system-dependent and is provided by the system developer. This configuration file lists all messages that the content manager 203 must process, together with what data should be extracted from each message and where the message should be routed inside the content manager 203. The system communicator configuration file 306 also lists all allowed outgoing messages and rules of their composition.

The main document controlling the system's communication is the message dictionary, an XML document defining every message's structure and data load. The system communicator configuration file 306 is dependent on the message dictionary since it refers to message names and data fields listed in the message dictionary file. Every accepted incoming message updates the model cache component 302 of the content manager 203, filling appropriate variable(s) with updated data or, if the only message's sense is an event, filling a special event variable with the proper event name. The model cache 302 in turn notifies the rest of the content manager components that the update occurred, resulting in the user interface content being generated and sent to the user screen. Filling of both message dictionary and system communicator configuration files is a system developer responsibility because those files are part of the system logic. An example of a single message dictionary XML syntax follows:

```
<Message EventId=”3” Topic=”Money” name=”Credit”>
    <Description>
      Monetary will publish the current credit amount.
    </Description>
    <Publishers>
      MON
    </Publishers>
    <Subscribers>
      CM, PDS
    </Subscribers>
    <Payload>
      <Item Description=”The value of credit” name=“Credit”
      type=”int”/>
    </Payload>
</Message>
```

To process the “Credit” message, the system communicator configuration file 306 will contain the code:

```
<MessageIn name=”Credit” mcname=”StateMachine.action” mcvalue=
”Money.Credit”>
    <Item name=“Credit” mcname=”credit”/>
    </Payload>
</MessageIn>
```

The system communicator configuration file syntax example shown above illustrates the processing of the “Credit” message by the content manager. The <MessageIn> element defines an incoming message and all action the system communicator will take upon a reception of “Credit” message. The attribute name=“Credit” defines the name of the message; mcname=“StateMachine.action” defines the model Ccche variable “StateMachine.action” to be set by reception of this message to the value defined by the mcvalue=“Money.Credit” attribute. This will give the state machine an input event of name “Money.Credit”, because of the function of the “StateMachine.action” variable. The <Item> child element of <MessageIn> defines the processing of the data load of the message, where name=“Credit” attribute selects the data field of the message to process, and the mcname=“credit” attribute defines the target model cache variable in which the message data of the “Credit” data field will be placed. Note that in this example, the value of credit may be updated after the state machine received the credit change notification. To assure the correct order of the data update, the system developer should choose the order of operators in the system communicator configuration file.

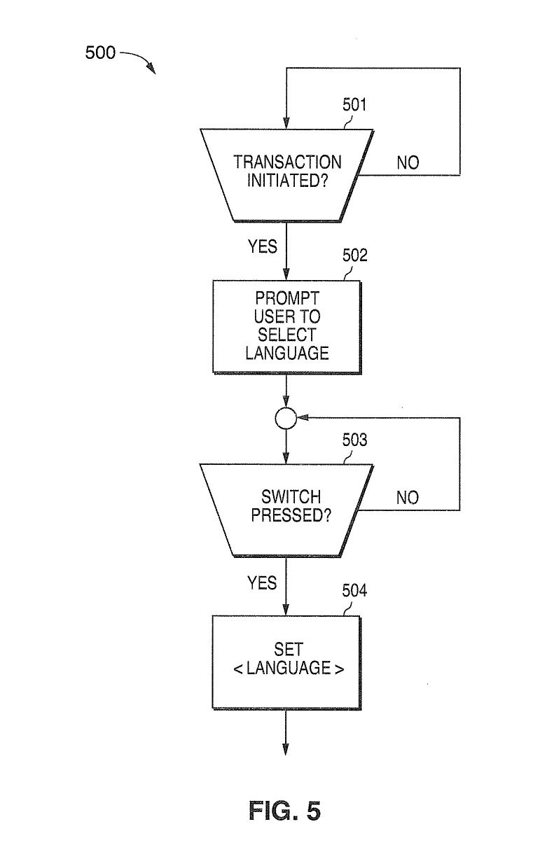

FIG. 5 is a high level flow diagram for a process of employing markup language descriptions for dynamic customer interface language selection for a graphical user interface within a brewed beverage vending machine according to one embodiment of the present disclosure. The content manifest file defines the user interface content composition according to the changes in the system's state, and thus may be employed as a “translation dictionary” in conjunction with dictionary configuration XML files, and word elements within user interface display content. Dictionary configuration XML files consist of a list of phrases used in user interface content, translated to individual (human) languages. One dictionary file is used per each user interface language. The file system directory which contains all the available dictionaries is specified at the content manager startup with “-dict” command line argument. The <language> element is the root element of a dictionary XML file. The attribute “caption” contains the name of selected language written in it (e.g. “Nederlands”). The attribute “name” gives the unique internal identifier name for this language (e.g. “NL”). The attributes “software_version” (e.g. “1.2.0”) and “file_version” (e.g. “01”) identify the version of this dictionary file, also used in service mode. The attribute “money_separator” contains the substring used as digit group separator (thousands separator) (e.g. “,” or “ ”). The attribute “money_decimal_separator” defines the decimal separator used when displaying numbers with decimal fractions (e.g. “.”). The attribute “money_sign” sets the money sign for the current language (e.g. “$”). The attribute “money_sign_position” specifies where the currency sign is attached to a sum (e.g. “left”). The attribute “service_mode” means this language file contains translations for service mode applications (e.g. “yes”). An example of XML syntax for the “language” element follows:

```
<language caption=“Nederlands” name=“NL” software_version=“1.2.0”
  file_version=“01” money_separator=“ ” money_decimal_separator=
  “.”
  money_sign=“$” money_sign_position=“left” service_mode=“yes”>
```

Child elements of <language> element are <word> elements, one per individual word/phrase. The <word> element is used to define the individual word/phrase in the selected language. For a phrase to be found by the content manager 203, both “key” and “group” attributes must be matched. The “key” attribute defines the phrase identifier which is used for the dictionary lookup, together with the “group” attribute. The “group” attribute contains the group name of phrases. The “value” attribute contains the text of the word/phrase in the selected language. An example of XML syntax for the “word” element follows:

<word key=“DECAFFE_CAFE_LATTE” group=“Products” value=“Cafeïnevrije Koffie”/>

The process 500 of employing markup language descriptions for dynamic customer interface language selection depicted in FIG. 5 begins with a customer initiating a vend transaction. Prior to such initiation, the main display area 104a of the user graphical display 104 may display the phrase such as “Press any key to start.” The display may cycle through a loop displaying that message briefly in each of the different languages supported by the vending machine 100 (e.g., “Press any key to start,” then “Appuyez sur n'importe quelle touche pour commencer,” then “Drücken Sie jede mögliche Taste, um zu beginnen,” then “Pulse cualquier tecla para comenzar,” etc.) This loop may be simply graphical content, rather than being text-based. While cycling through that loop, the VMC 106 and content manager 203 may monitor for a key to be pressed, indicating initiation of a vend transaction by the customer. In alternative embodiments, the vend transaction may be initiated instead by insertion of payment, or some different event.

Once a vend transaction has been initiated, the customer may be prompted to select a language by, for example, displaying the message “Please select language” in the main display area 104a (step 501). As described above, this message may be displayed in each of the different languages supported by the vending machine 100, cycling through the display in each language in a looped manner. The label display areas 104b-104m may display the various languages supported—i.e., “English” in area 104b, “Français” in area 104c, “Deutsch” in area 104d, “Español” in area 104e, etc., with the remaining areas 104e-104m remaining blank. When a switch is detected as being pressed (step 503), the event results in the XML <language> element being set with a code representing the selected language in the model cache 302 (step 504). That value is then used by mapper 304 to select the correct content for display of text in the main display area 104a and the label display areas 104b-104m throughout the remainder of the vend transaction, using the corresponding language dictionary configuration XML file to lookup the values for each <word> element within the content generated for user interface display updates.

The present disclosure enables dynamic customization of language for text portions of content to be displayed in the customer interface within a vending machine using XML language dictionaries selected based on a variable setting and populating content for <word> elements with the appropriate language values. Dictionaries can be added to vending machine to add additional languages, such as when the vending machine is moved or when the population frequenting a given location changes due to immigration or for special situations (e.g., sporting events).

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A system dynamically generating human language text for display on a vending machine customer interface, comprising:
a display configured to display human language text to a customer as part of display content;
one or more memories configured to store a value for an eXtensible Markup Language (XML) human language variable and a plurality of XML human language dictionaries, each dictionary containing values for XML word elements in one of a plurality of human languages, the XML word elements corresponding to human language text to be displayed on the display; and
a controller configured to generate updates for display content, the controller selecting one of the plurality of human language dictionaries based on the value of the XML human language variable and retrieving values for the XML word elements within the display content to be displayed from the selected dictionary,
wherein text portions of the display content displayed on the display are dynamically populated with human language words from the selected XML human language dictionary.

2. The system of claim 1, wherein the value of the XML human language variable is set based on a customer's selection of human language options presented for a particular vend transaction.

3. The system of claim 2, wherein the value of the XML human language variable may be changed for consecutive vend transactions, such that human language text within the display content displayed during different vend transactions is displayed in different human languages.

4. The system of claim 1, wherein the memory is configured to store the value of the XML human language variable in a model cache.

5. The system of claim 4, wherein the controller is configured to execute a content manager generating XML data for the display content, the content manager looking up values for XML word elements within the model cache.

6. The system of claim 5, wherein the content manager includes the model cache and a mapper mapping XML data to presentation layer data rendered to generate the display content.

7. The system of claim 5, wherein the content manager includes a configuration file identifying XML dictionary files corresponding to the plurality of human language dictionaries.

8. The system of claim 5, wherein the content manager includes a state machine controlling a state of the content manager and transitions between states by the content manager.

9. A vending machine including the system of claim 1, the vending machine further comprising:
a cabinet housing the display, the memory and the controller; and
a product delivery system configured to deliver products in response to signals generated by the controller based upon a customer's selections within the customer interface.

10. The vending machine of claim 9, wherein the vending machine is configured to delivery brewed beverages.

11. A method of dynamically generating human language text for display on a vending machine customer interface, comprising:
displaying human language text to a customer as part of display content;
storing a value for an eXtensible Markup Language (XML) human language variable and a plurality of XML human language dictionaries, each dictionary containing values for XML word elements in one of a plurality of human languages, the XML word elements corresponding to human language text to be displayed; and
generating updates for display content by selecting one of the plurality of human language dictionaries based on the value of the XML human language variable and retrieving values for the XML word elements within the display content to be displayed from the selected dictionary,
wherein text portions of the display content displayed on the display are dynamically populated with human language words from the selected XML human language dictionary.

12. The method of claim 11, wherein the value of the XML human language variable is set based on a customer's selection of human language options presented for a particular vend transaction.

13. The method of claim 12, wherein the value of the XML human language variable may be changed for consecutive vend transactions, such that human language text within the display content displayed during different vend transactions is displayed in different human languages.

14. The method of claim 11, further comprising storing the value of the XML human language variable in a model cache.

15. The method of claim 14, further comprising executing a content manager generating XML data for the display content, the content manager looking up values for XML word elements within the model cache.

16. The method of claim 15, wherein the content manager includes the model cache and a mapper mapping XML data to presentation layer data rendered to generate the display content.

17. The method of claim 15, wherein the content manager includes a configuration file identifying XML dictionary files corresponding to the plurality of human language dictionaries.

18. The method of claim 15, wherein the content manager includes a state machine controlling a state of the content manager and transitions between states by the content manager.

19. A method of claim 11, further comprising:
delivering products in response to signals generated based upon a customer's selections within the customer interface.

20. The method of claim 19, further comprising delivering brewed beverages.
